(19) United States
(12) Patent Application Publication
(10) Pub. No.: US 2008/0050671 A1
(43) Pub. Date: Feb. 28, 2008

(54) IMAGE FORMING METHOD

(75) Inventors: Hiroshi YAMAZAKI, Tokyo (JP); Ken OHMURA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/781,335

(22) Filed: Jul. 23, 2007

(30) Foreign Application Priority Data
Aug. 8, 2006 (JP) 2006-215413

(51) Int. Cl. G03G 15/09; G03G 13/09

(52) U.S. Cl. 430/122.2; 399/267; 399/270; 399/272; 399/273

(57) ABSTRACT

An image forming method, comprising the steps of: agitating a mixture of toner particles and carrier particles so as to electrically charge the toner particles; forming a charged toner layer on a toner conveying roller by extracting the charged toner particles from the mixture; forming an electrostatic latent image on an image carrying member; and conveying the charged toner layer by the toner conveying roller so as to develop the electrostatic latent image on the image carrying member with charged toner; wherein the carrier particles are carrier particles each formed by dispersing magnetic fine powder in a binder resin and have a shape coefficient SF-1 of 1.0 to 1.2, a shape coefficient SF-2 of 1.1 to 2.5, and a volume-based median size of 10 to 100 μm.

This application is based on Japanese Patent Application No. 2006-215413 filed on Aug. 8, 2006, in Japanese Patent Office, the entire content of which is hereby incorporated by reference.

### BACKGROUND OF THE INVENTION

The present invention relates to an image forming method employing a hybrid developing method.

Recently, not only in a copying machine and a printer, but also in a small size printing machine, an image forming is conducted by employing an electro photographic method.

In the electro photographic method, a two component developer (a two component type developing agent) including toner and carrier is a developer suitable for high speed developing in comparison with a one component type developer which is excellent in dot reproducibility capable of obtaining high image resolution.

However, when a magnetic brush is formed with the two component developer by magnetism and conveyed to a developing region, there may be a problem that the magnetic brush rubs the surface of an electrostatic latent image carrying member and causes image disturbance.

In order to solve this problem, Japanese Patent O.P.I. Patent Publication Nos. 2000-131884, 2003-149935, 2005-134898, 2002-333775, and 2005-55840 suggest an image forming apparatus employing a hybrid developing method. In the hybrid developing method, toner is charged by use of carrier, then only the charged toner is transferred electrically to a toner conveying roller (developing roller) so as to form a uniform toner layer of the charged toner on the toner conveying roller, and an electrostatic latent image is developed with a non contact developing technique to let toner to jump in a developing gap from the toner layer.

However, although the hybrid developing method makes it possible to obtain an image with an excellent dot reproducibility and a high image resolution and to conduct a high speed development, it becomes difficult to form a charged toner layer with a high uniformity as carrier is deteriorating. As a result, there is a problem that image density irregularities are caused during a usage for a long term.

Incidentally, as career in two component developer, it is disclosed that a resin distribution type carrier in which a magnetic fine powder is distributed in a phenol-formaldehyde resin, is light weight and high hardness (for example, refer to Japanese Patent O.P.I. Patent Publication No. 2001-201893). However, there are problems that when carrier containing a phenol-formaldehyde resin is used, for example, the carrier caused water absorption in a usual contact type development with a two component developer, then water shifts to an electrostatic latent image carrying member, and successively so-called flow occurs on a surface potential of the electrostatic latent image carrying member resulting in that image blur may be induced.

### SUMMARY

The present invention has been conceived in view of the above circumstances and an object of the present invention is to provide an image forming method capable of forming a good image stably for a long term even in an image forming apparatus with a high speed development.

The above object can be attained by the following image forming method on which an aspect of the present invention is reflected.

An image forming method, comprises the steps of:

(1) agitating a mixture of toner particles and carrier particles so as to electrically charge the toner particles;

(2) forming a charged toner layer on a toner conveying roller by moving the charged toner particles from the mixture;

(3) forming an electrostatic latent image on an image carrying member; and

(4) conveying the charged toner layer with the toner conveying roller so as to develop the electrostatic latent image on the image carrying member;

wherein the carrier particles are carrier particles each formed by dispersing magnetic fine powder in a binder resin and have a shape coefficient SF-1 of 1.0 to 1.2, a shape coefficient SF-2 of 1.1 to 2.5, and a volume-based median size of 10 to 100 μm.

### BRIEF DESCRIPTION OF THE DRAWINGS

FIG. 1 is a schematic view to explain a hybrid developing method in the present invention.

### DETAILED DESCRIPTION OF THE PREFERRED EMBODIMENT

Hereinafter, preferable embodiments of the present invention will be explained, however, the present invention is not limited to these preferable embodiments.

Firstly, preferable image forming methods to attain the above objects are explained.

In an image forming method of developing an electrostatic latent image formed on the surface of an electrostatic latent image carrying member with toner in a charged toner layer formed on a toner conveying roller located opposite to the electrostatic latent image carrying member, the image forming method of the present invention is characterized in that the charged toner layer on the toner conveying roller is formed by use of a two component developer including at least toner and carrier and the carrier is made by dispersing magnetic fine powder in a binder resin and has a shape coefficient SF-1 of from 1.0 to 1.2, a shape coefficient SF-2 of from 1.1 to 2.5 and a volume-based median size of from 10 to 100 μm.

In the image forming method of the present invention, the binder resin constituting the carrier may be a phenol-formaldehyde resin.

According to the image forming method of the present invention, since carrier is not brought in contact with a electrostatic latent image carrying member by adopting a hybrid developing method employing a toner conveying roller, brush marks of carrier are not formed on a developed image, a uniformity with a high image density can be obtained specifically even in a solid image, and a high image resolution can be obtained with achievement of a high reproducibility of a thin line by developing surly minute dots.

Further, since carrier constituting the two component developer is composed of resin-dispersion type carrier (hereafter, referred as “specific resin-dispersion type carrier” or “magnetic powder dispersion type resin carrier”) having a specific shape and has high durability, a stable charge providing capability can be obtained for a long term so that a charged toner layer with a high uniformity can be formed on the toner conveying roller. Accordingly, a stable developing ability can be obtained for a long term. As a result, a good image can be formed stably for a long term.

Further, as stated above, when carrier containing a phenol-formaldehyde resin is used, for example, the carrier caused water absorption in a usual contact type development with a two component developer, then water shifts to an electrostatic latent image carrying member, and successively so-called flow occurs on a surface potential of the electrostatic latent image carrying member resulting in that image blur may be induced. However, according to the image forming method of the present invention, since carrier does not cause the flow on a surface potential of the electrostatic latent image carrying member, occurrence of image blur may be refrained even if the carrier containing a phenol-formaldehyde resin is used.

Namely, the carrier has a high durability and a high toughness owing to a high cross-liking structure of the phenol-formaldehyde resin forming the carrier, and since the carrier is not brought in contact with the electrostatic latent image carrying member, image blur does not take place. Therefore, the advantages of the carrier containing a phenol-formaldehyde resin can be utilized at a maximum.

Hereinafter, the image forming method of the present invention will be explained in detail.

The image forming method of the present invention is to visualize an electrostatic latent image formed on an electrostatic latent image carrying member with a developing device employing a so-called hybrid developing method by use of a two component developer including resin-dispersion type carrier which is made by dispersing magnetic fine powder in a binder resin and has a specific shape.

Hereinafter, the two component developer used in the image forming method of the present invention will be explained.

### [Toner]

A toner constituting a two-component developer according to the present invention may be made to contain, for example, a binder resin and a colorant.

A method of manufacturing such toner is not limited specifically, and as the method, a pulverizing method, a suspension polymerization method, a mini emulsion polymerization condensation method, an emulsion polymerization condensation method, a melting suspension method, a polyester molecule elongating method and well-known other methods may be employed. Especially, since the image forming method of the present invention can electrically charge toner with high uniformity over a long period of time even if the toner is shaped in an infinite form, it is stabilized over a long period of time, the image forming method can form an image with excellent image quality stably for the long period of time.

### [Suspension Polymerization Method]

The suspension polymerization method is performed as follows. That is, toner constituents, such as a releasing agent and a colorant and a radical polymerization initiator are added in a radical polymerizable monomer, and these are dissolved or dispersed in the radical polymerizable monomer with a sand grinder etc. so as to form a uniform monomer dispersion liquid, and subsequently the uniform monomer dispersion liquid is added in a water base medium in which a dispersion stabilizer was added beforehand, and the uniform monomer dispersion liquid is dispersed in the water base medium with a homomixer, a ultrasonic homogenization, etc., thereby forming oil droplets. Here, since the size of the oil droplets becomes finally a size of toner, the dispersion is controlled so as to obtain a desired size. The size of the dispersed oil droplets is preferably made to be a volume average median size of from 3 μm to 10 μm. Subsequently, a polymerization process is carried out with heating, and, coloring particles can be obtained by removing the dispersion stabilizer, by rinsing and drying after the polymerization reaction completes, and further toner particles can be obtained by adding and mixing an external additive agent as necessary.

### [Binder Resin]

In the case that toner particles constituting a toner are manufactured by the pulverizing method, the melting suspension method, and so on, as a binder resin constituting the toner, various well-known resins such as a styrene type resin, a (meth) acryl type resin, a styrene-(meth) acryl type copolymer resin, a vinyl resin such as an olefin type resin, a polyester type resin, a polyamide type resin, a polycarbonate resin, a polyether, a polyvinyl acetate type resin, a polysulfone, an epoxy resin, a polyurethane resin, and urea resin may be used. These may be used solely with one type or in combination with two types or more.

A releasing agent, a colorant, and so on are added to the binder resin, and the resultant mixed material is kneaded by using a bi-axle kneading machine, subsequently pulverized and classified, whereby toner particles can be obtained.

When the toner particles are prepared by the suspension polymerization method, mini-emulsion polymerization-coagulation method or emulsion polymerization-coagulation method, for example, the following can be used as the polymerizable monomer for forming the resin to obtain the resin for constituting the toner: A vinyl type monomer, for example, styrene or a styrene derivative such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, p-n-hexylstyrene, p-n-octylstyrene p-n-nonylstyrene, p-n-decylstyrene and p-n-dodecylstyrene; a methacrylate derivative such as methyl methacrylate, ethyl methacrylate, n-butyl methacrylate, iso-propyl methacrylate, iso-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate; an acrylate derivative such as methyl acrylate, ethyl acrylate, iso-propyl acrylate, n-butyl acrylate, t-butyl acrylate, iso-butyl acrylate, n-octyl acrylate, 2-ethylhexyl acrylate, stearyl acrylate, lauryl acrylate and phenyl acrylate; an olefin such as ethylene, propylene and iso-butylene, a vinyl halide such as vinyl chloride, vinylidene chloride, vinyl bromide, vinyl fluoride and vinylidene fluoride; a vinyl ester such as vinyl propionate, vinyl acetate and vinyl benzoate; a vinyl ether such as vinyl methyl ether and vinyl ethyl ether; a vinyl ketone such as vinyl methyl ketone, vinyl ethyl ketone and vinyl hexyl ketone; an N-vinyl compound such as N-vinylcarbazole, N-vinylindole and N-vinyl pyrrolidone; a vinyl compound such as vinylnaphthalene and vinylpyridine; and an acrylic acid or a methacrylic acid derivative such as acrylonitrile and acrylamide. These vinyl type monomers may be used singly or in combination of two or more kinds of them.

Moreover, a monomer having an ionic dissociable group is preferably used in combination with the above resin. The polymerizable monomer having an ionic dissociable group is one having a substituent such as a carboxyl group, a sulfonic acid group or a phosphoric group; concretely acrylic acid, methacrylic acid, maleic acid, itaconic acid, cinnamic acid, fumaric acid, a mono-alkyl maleate, a mono-alkyl itaconate, styrenesulfonic acid, allyl sulfosuccinate, 2-acrylamide-2-methylpropanesulfonic acid, acidphosphoxyethyl methacrylate and 3-chloro-2-acidphosphoxypropyl methacrylate are cited.

Furthermore, binder resins having crosslinked structure can be obtained by using a multifunctional vinyl compounds as the polymerizable monomer; concrete examples are divinylbenzene, ethylene glycol dimethacrylate, diethylene glycol diacrylate, diethylene glycol dimethacrylate, diethylene glycol diacrylate, triethylene glycol diacrylate, neopentyl glycol dimethacrylate and neopentyl glycol diacrylate.

### [Surfactant]

When the toner particle constituting the toner is prepared by the suspension polymerization method, mini-emulsion method or the emulsion polymerization, the surfactant usable for obtaining the binder resin is not specifically limited. Ionic surfactants, for example, a sulfonic acid salt such as sodium dodecylbenzenesulfonate and sodium aryl-alkyl polyether sulfonate, sulfuric acid ester salt such as sodium dodecylasulfate, sodium tetradecylsulfate, sodium pentadecylsulfate, sodium pentadecylsulfate and sodium octylsulfate, a fatty acid salt such as sodium oleate, sodium laurate, sodium caprate, sodium caprylate, sodium capronate, potassium stearate and calcium oleate can be cited as suitable examples. A nonionic surfactant such as polyethylene oxide, polypropylene oxide, a combination of polypropylene oxide and polyethylene oxide, an ester of polyethylene glycol and a higher fatty acid, an alkylphenol polyethylene oxide, an ester of higher fatty acid and polypropylene oxide and a sorbitan ester is also usable. These surfactants are used as an emulsifying agent when the toner is produced by the emulsion polymerization but they may be used for another process and another purpose.

### [Dispersion Stabilizer]

In the case that toner particles constituting a toner are manufactured by a suspension polymerization method, a dispersion stabilizer composed of easily removable inorganic compounds also may be used. As the dispersion stabilizer, for example, tricalcium phosphate, magnesium hydroxide, hydrophilic colloidal silica, etc. may be listed up, and especially, tricalcium phosphate is desirable. Since this dispersion stabilizer is decomposed easily with an acid, such as hydrochloric acid, this dispersion stabilizer can be easily removable from the surface of toner particles.

### [Polymerization Initiator]

In the case of the suspension polymerization, an oil soluble radical polymerization initiator can be used. Examples of oil-soluble polymerization initiator include an azo type or diazo type polymerization initiator such as 2,2′-azobis-(2,4-dimethylvaleronitrile), 2,2′-azobis-isobutylnitrile, 1,1′-azobis(cyclohexane-1-carbonitrile), 2,2′-azobis-4-methoxy-2,4-dimethylvaleronitrile and azobisisobutylonitrile, a peroxide type polymerization initiator such as benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxicyclohexyl)propane and tris-(t-butyl peroxide), and a polymer initiator having a peroxide moiety at a side-chain thereof.

### [Chain Transfer Agent]

In the case that toner particles constituting a toner are manufactured by a suspension polymerization method, a mini emulsion polymerization condensation method, or an emulsion polymerization condensation method, a chain transfer agent being generally used can be used for the purpose of adjusting the molecular weight of a binder resin.

The chain transfer agent is not particularly limited, and as the chain transfer agent, for example, mercaptan, such as octylmercaptan, dodecylmercaptan, tert-dodecylmercaptan; n-octyl-3-mercaptopropionic acid ester, terpinolene, carbon tetrabromide and α-methyl styrene dimer, may be employed.

### [Colorant]

As a colorant constituting a toner, a well-known inorganic colorant or organic colorant may be used.

A concrete colorant is shown below.

As a black colorant, for example, carbon black such as furnace black, channel black, acetylene black, thermal black and lamp black; and magnetic powder such as magnetite and ferrite are employable.

Moreover, the image forming method according to the present invention may form a monochrome image, and also may form a color image.

As a colorant for magenta or red in the case of forming a color image, C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C.I. pigment red 53:1, C.I. pigment red 57:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 166, C. I. Pigment Red 177, C. I. pigment red 178, C.I. pigment red 222, etc. may be listed.

As a colorant for orange or yellow in the case of forming a color image, C. I. Pigment Orange 31, C. I. Pigment Orange 43, C. I. Pigment Yellow 12, C. I. Pigment Yellow 13, C. I. Pigment Yellow 14, C. I. Pigment Yellow 15, C.I. Pigment Yellow 74, C.I. pigment yellow 93, the C.I. pigment yellow 94, the C.I. pigment yellow 138, etc. may be listed.

As a colorant for green or cyan in the case of forming a color image, C.I. pigment blue 15, the C.I. pigment blue 15:2, the C.I. pigment blue 15:3, the C.I. pigment blue 15:4, the C.I. pigment blue 16, the C.I. pigment blue 60, the C.I. pigment blue 62, the C.I. pigment blue 66, the C.I. pigment green 7, etc. may be listed.

The above colorants may be used solely or in a combination of two or more kinds.

Moreover, an added amount of the colorant may be made within a range of 1-30 weight %, preferably within a range of 2 to 20 weight % for the whole of a toner.

As the colorant, a colorant having been subjected to a surface modification also may be used. As the surface modifying agent, a conventionally well-known surface modifying agent may be used. More concretely, a silane coupling agent, a titanium coupling agent, and an aluminum coupling agent may be preferably employed.

### [Releasing Agent]

In toner particles constituting a toner, a releasing agent may be contained if needed. As the releasing agent, well-known various kinds of waxes may be used.

The added amount of the releasing agent in a toner is desirably 1-30 weight % for a binder resin, and more desirably 5-20 weight %.

### [Electric Charge Control Agent]

Moreover, in toner particles constituting a toner, an electric charge control agent may be contained if needed. As the electric charge control agent, well-known various kinds of compounds may be used.

### [Particle Size of Toner Particles]

The particle size of toner particles may be desirably 3 to 8 μm as the volume average median size. This particle size may be controlled by the adjustment of the dispersion size of oil droplets when the toner particles are manufactured by a suspension polymerization method.

When the volume average median size is made within a range of 3 to 8 μm, the reproducibility of a micro-line and the high image quality of a photographic image can be attained, in addition, the amount of consumption of toner can be reduced in comparison with the case where a relatively large size toner is used.

The volume average median size of toner particles can be measured by using a Coulter Multi-Sizer (manufactured by a coulter company) with an aperture of 50 μm and a particle size distribution in the range of 2.0 to 40 μm.

### [External Additive Agent]

For the purpose of improving fluidity and chargeability, as well as of enhancing cleaning properties, so-called external additives added into such a toner can be used. These external additives are not particularly limited, but various kinds of fine inorganic and organic particles, as well as lubricant can be used.

As the inorganic fine particles, inorganic oxide particles, such as silica, titania, and alumina may be preferably used. Further, the inorganic fine particles are preferably subjected to a hydrophobilizing process with a silane coupling agent, a titanium coupling agent, etc. Further, spherical particles having a number average primary particle size of from 10 to 2,000 nm may be employed as the organic fine particles. As this organic fine particles, a polymer, such as a polystyrene, a polymethylmethacrylate, and a styrene-methyl methacrylate copolymer, may be used.

The addition rate of these external additive agents is 0.1 to 5.0 weight % in toner, preferably 0.5-4.0 weight %. Moreover, as the external additive agents, various kinds of external additive agents may be used in combination.

### [Carrier]

A carrier constituting a two-component developer is a specific resin dispersion type carrier which has a specific shape with a shape coefficient SF-1 of 1.0 to 1.2, a shape coefficient SF-2 of 1.1 to 2.5 and a volume average median size of 10 to 100 μm and in which magnetic-substance fine powder is dispersed in a binder resin.

### [Magnetic-Substance Fine Powder]

As the magnetic-substance fine powder constituting a specific resin dispersion type carrier, a fine powder which is composed of well-known magnetic materials, for example, a metal or a metal oxide such as iron, a ferrite represented by formula a): MO.Fe₂O₃, and a magnetite represented by formula b): MFe₂O₄, an alloy of these metals or metal oxides and a metal, such as aluminum and lead may be used. Here, in the formulas a) and b), M represents a metal of divalent or monovalent, for example, such as Mn, Fe, Ni, Co, Cu, Mg, Zn, Cd, and Li, and these are used solely, or in combination of two or more kinds.

As a concrete example of magnetic-substance fine powder, for example, a magnetite, a γ iron oxide, a Mn—Zn type ferrite, a Ni—Zn type ferrite, a Mn—Mg type ferrite, a Ca—Mg type ferrite, a Li type ferrite, a Cu—Zn type ferrite, etc. may be exemplified.

The content of the magnetic-substance fine powder in a specific resin dispersion type carrier is 40 to 99 weight %, preferably 50-70 weight %.

These magnetic-substance fine powder desirably has a number average primary size of 0.1 to 0.5 μm. The number average primary size is an arithmetic mean value obtained such that the diameter in the Ferre direction of 100 magnetic-substance fine powders are measured by using an electron microscope photograph magnified by 10,000 times and the arithmetic mean value is obtained from the measurements.

Moreover, for the purpose of the adjustment of magnetic property etc., a nonmagnetic metal oxide powder in which non-magnetic metals, such as Mg, aluminum, Si, Ca, Sc, Ti, V, Cr, Mn, Fe, Co, nickel, Cu, Zn, Sr, Y, Zr, Nb, Me, Cd, Sn, Ba, and Pb is used solely or in combination of two or more kinds, may be used together with the above-mentioned magnetic-substance fine powder. As concrete examples of the nonmagnetic metal oxide powder, for example, Al₂O₃, SiO₂, CaO and TiO₂, V₂O₅, CrO₂, MnO₂, Fe₂O₃, CoO, NiO, CuO, ZnO and SrO, Y₂O₃, ZrO₂ type, etc. may be listed up.

These nonmagnetic metal oxide powders are desirably a powder having a number average primary particle size of 0.1 to 1.0 μm.

The content of the nonmagnetic metal oxide powder in a specific resin dispersion type carrier is 10 to 60 weight %, preferably 20-40 weight %.

From a viewpoint of increasing lipophilicity and hydrophobicity, the surface of the magnetic-substance fine powder is subjected to a lipophilization process with a lipophilization processing agent, such as various coupling agents and higher fatty acids, and thereafter, the magnetic-substance fine powder may be used.

The added amount of the lipophilization processing agent is desirably 0.1 to 10 parts by mass for 100 parts by mass of the magnetic-substance fine powder, more preferably 0.2 to 6 parts by mass.

### [Binder Resin]

A binder resin constituting a specific resin dispersion type carrier is not limited specifically, but well-known resin may be used, concretely, for example, various resins such as a styrene-acryl type resin, a polyester resin, a fluororesin, a phenol formaldehyde resin, an epoxy resin, a urea resin, and a melamine resin may be listed up. In particular, according to the image forming method of the present invention, even if a binder resin is a phenol formaldehyde resin, an image with an excellent image quality can be formed stably over a long period of time.

As the binder resin, a heat-hardenable resin in the state where a part or all of the heat-hardenable resin is cross-linked three dimensionally, because the magnetic-substance fine powder dispersed in the binder resin can be firmly bound. By using such a cross-linkable binder resin, a hardness of the carrier itself can be made higher, and the carrier can be made to have a higher durability. As a result, even when an image formation is conducted many times, the occurrence of detachment of the magnetic-substance fine powder can be fully suppressed.

### [Production Method of a Carrier]

Such a specific resin dispersion type carrier may be manufactured, for example, by a method having been referred to as a polymerizing method.

By manufacturing the specific resin dispersion type carrier by the polymerizing method, since a shape near a true ball is acquired for the carrier, carrier contamination can be suppressed, and since the surface uniformity is acquired, high charge providing ability can be obtained. In addition, the shape of the carrier can be controlled easily at the time of production.

In the case that a binder resin constituting a specific resin dispersion type carrier is a phenol formaldehyde resin, for example, a raw material monomer such as a phenol and aldehyde and a magnetic-substance fine powder are added in a water base media containing a dispersion stabilizer, such as tricalcium phosphate, magnesium hydroxide and hydrophilicity silica in a colloid state, dissolved or dispersed in the water base media. And then, a polymerization process (addition condensation reaction) is conducted in the resultant solution under the existence of a basic catalyst, whereby the phenol formaldehyde resin can be obtained.

With the similar way, a melamine resin can be obtained by using melamine and aldehyde as a raw material monomer, and an epoxy resin can be obtained using bisphenol and an epichlorohydrin as a raw material monomer without adding a basic catalyst, and a urea resin can be obtained using urea and aldehyde as a raw material monomer without adding a basic catalyst.

### [Basic Catalyst]

As the basic catalyst used in the case that the binder resin is a phenol formaldehyde resin or a melamine resin, for example, an aqua-ammonia, hexamethylenetetramine and alkylamine, such as dimethylamine, diethyl tri amine, polyethylene imine, etc., may be listed. These basic catalysts are preferably added by 0.02 to 0.3 mol to one mol of phenol.

As a phenol used in the case that the binder resin is the phenol formaldehyde resin, although a compound having a phenolic hydroxyl, such as alkylphenol, such as phenol, m-cresol, p-tert-butyl phenol, o-propyl phenol, resorcinol, and bisphenol A; halogenation phenol in which some or all of a benzene nucleus or an alkyl group are substituted with a chlorine atom or a bromine atom, may be listed up, especially phenol is desirable because high particle shape ability can be obtained.

As an aldehyde used in the case that the binder resin is the phenol formaldehyde resin, although a formaldehyde and a furfural in a state of one of formalin or paraformaldehyde may be listed, formaldehyde is desirable.

Moreover, a specific resin dispersion type carrier may be also manufactured by a method called as a suspension polymerization method. Namely, in a radical polymerizable monomer, magnetic-substance fine powder is dispersed and then a radical polymerization initiator is added so as to prepare a carrier polymerization composition, and subsequently, the carrier polymerization composition is dispersed as oil droplets in a water base media which contains a dispersion stabilizer, such as tricalcium phosphate, magnesium hydroxide and hydrophilicity silica in a colloid state and is preferably added with a small amount of an anionic surfactant, then a radical polymerizing process is conducted in the water base media, whereby the resin dispersion type carrier can be obtained. At the time of dispersion, a particle size of the oil droplets is made to be 10 to 100 μm in the volume average median size, preferably 15 to 80 μm. The particle size of the oil droplets at the time of dispersion becomes a particle size of an obtained specific resin dispersion type carrier.

### [Radical Polymerizable Monomer]

As the radical polymerizable monomer for obtaining the specified resin dispersion type carrier by the suspension polymerization method, the followings are cited: A vinyl type monomer, for example, styrene and its derivative such as styrene, o-methylstyrene, m-methylstyrene, p-methylstyrene, α-methylstyrene, p-chlorostyrene, 3,4-dichlrostyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene and p-n-dodecylstyrene; a methacrylate derivative such as methyl methacrylate, ethyl methacrylate, n-butyl methacrylate, isopropyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate; an acrylate derivative such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate and phenyl acrylate; an olefin compound such as ethylene, propylene and isobutylene; a vinyl halide compound such as vinyl chloride, vinylidene chloride, vinyl bromide, vinyl fluoride and vinylidene fluoride; a vinyl ester such as vinyl propionate, vinyl acetate and vinyl benzoate; a vinyl ether such as vinyl methyl ether and vinyl ethyl ether; a vinyl ketone such as vinyl methyl ketone, vinyl ethyl ketone and vinyl hexyl ketone; an N-vinyl compound such as N-vinylcarbazole, N-vinylindole and N-vinylpyridine; a derivative of acrylic acid or methacrylic acid such as for example, acrylonitrile, methacrylonitrile and arylamide. These vinyl type monomers can be used singly or in combination of two or more kinds of them.

### [Radical Polymerization Initiator]

As the radical polymerization initiator to be used for producing the specified resin dispersion type carrier by the suspension polymerization method, an oil-soluble initiator, for example an azo type or diazo type polymerization initiator such as 2,2′-azobis-(2,4-dimethylvaleronitrile), 2,2′-azobis-isobutylnitrile, 1,1′-azobis(cyclohexane-1-carbonitrile), 2,2′-azobis-4-methoxy-2,4-dimethylvaleronitrile and azobis-isobutylonitrile, a peroxide type polymerization initiator such as benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxicyclohexyl)propane and tris-(t-butyl peroxide), and a polymer initiator having a peroxide moiety at a side-chain thereof are applicable.

### [Chain Transfer Agent]

In the case that toner particles constituting a toner are manufactured by a suspension polymerization method, a mini emulsion polymerization condensation method, or an emulsion polymerization condensation method, a chain transfer agent being generally used can be used for the purpose of adjusting the molecular weight of a binder resin.

The chain transfer agent is not particularly limited, and as the chain transfer agent, for example, mercaptan, such as octylmercaptan, dodecylmercaptan, tert-dodecylmercaptan; n-octyl-3-mercaptopropionic acid ester, terpinolene, carbon tetrabromide and α-methyl styrene dimer, may be employed.

In the present invention, the specific resin dispersion type carrier may be made a coated carrier in which the surface of carrier particles is coated with a coat resin which is chosen appropriately in accordance with a charge amount of a toner from a viewpoint to acquire an optimum charging characteristic, an optimum charging amount, and a high durability.

In the case that carrier particles are coated with a coat resin, it is desirable that the coat resin is coated to become in a range of from 0.1 to 10 weight %, more preferably from 0.3 to 5 weight % for carrier particles to be a core particle.

Further, in the coating with a coat resin, it is necessary to adjust a coating amount and a coating condition so as to make shape coefficients SF-1 and SF-2 of the obtained carrier to become predetermined values.

### [Coat Resin]

A thermoplastic or thermally curable insulating resin is suitably used as the coating resin. Concrete examples of the thermoplastic insulating resin include an acryl resin such as polystyrene, a copolymer of poly(methyl methacrylate) and a styrene-acrylic acid, a styrene-butadiene copolymer, vinyl chloride, vinyl acetate, poly(vinylidene fluoride) resin, fluorocarbon resin, perfluorocarbon resin, solvent-soluble perfluorocarbon resin, poly(vinyl alcohol), poly(vinyl acetal), polyvinylpyrrolidone, a petroleum resin, a cellulose derivative such as cellulose, cellulose acetate, cellulose nitrate, methyl cellulose, hydroxymethyl cellulose and hydroxypropyl cellulose, a novolac resin, low molecular weight polyethylene, an aromatic polyester resin such as a saturated alkyl polyester resin, poly(ethylene phthalate), poly(butylene phthalate) and polyallylate, polyamide resin, polyacetal resin, polysulfone resin, polyphenylene sulfide resin and poly(ether ketone) resin.

Examples of the thermally curable insulating resin include phenol resin, a modified phenol resin, a maleic resin, an alkyd resin, an epoxy resin and an acryl resin, in concrete, an unsaturated polyester formed by condensate polymerization of maleic anhydride-terephthalic acid-polyvalent alcohol, urea resin, melamine resin, xylene resin, toluene resin, guanamine resin, melamine-guanidine resin, acetoguanamine resin, glyptal resin, furan resin, silicone resin, polyimide, polyamidoimide resin, polyetherimide resin and polyurethane resin.

These coating resins may be used singly or in combination of two or more kinds of them. Moreover, it is allowed that a curing agent is mixed in the thermoplastic insulating resin for curing the coated resin.

As a method of coating of these coat resins on specific resin dispersion type carrier particles as a core particle, there may be a method of dissolving or dispersing a coat resin in an organic solvent so as to prepare a coat solution and coating the coat solution on carrier particles, and a method of merely mixing a coat resin shaped in powder like with carrier parcels so as to adhere the coat resin on the carrier particles may be employed.

A carrier constituting a two component developer according to the present invention is composed to carrier particles having a shape coefficient SF-1 of from 1.0 to 1.2 and a shape coefficient SF-2 of from 1.1 to 2.5.

Here, the shape coefficient SF-1 is an index which shows the degree of sphericity of carrier particles, and in the case of a true ball, SF-1 is set to 1. Further, the shape coefficient SF-2 is an index which shows the grade of fine convexoconcave of the surface of carrier particles, and when the surface is a smooth surface without convexoconcave, SF-2 is set to 1.

### [Shape Coefficient of Carrier]

The shape coefficient SF-1 and SF-2 of carrier particles can be measured such that 100 macro-photographs are taken for carrier particles at random by use of a field emission scanning electron microscope “S-4500” manufactured by Hitachi, Co. Ltd., and the 100 macro-photographs are analyzed by use of an image processing analyzing apparatus “Luzex3” manufactured by Nicolet Co. Ltd., and the mean value is calculated based on the shape coefficient obtained by the following formulas (SF-1) and (SF-2).

SF-1={(MXLNG)²/(AREA)}×(π/4) Formula (SF-1):

SF-2={(PERI)²/(AREA)}×(¼π) Formula (SF-2):

Here, in the above formulas (SF-1) and (SF-2), MXLNG represents the maximum diameter of carrier particles, AREA represents the projection area of carrier particles, and PERI represents the circumference length of carrier particles, respectively.

In this regard, the maximum diameter means the width of the carrier particles when a projection image of a carrier particle on a plane is pinched between two parallel lines and the distance between the parallel lines becomes the maximum. Also, the projection area means a area of an projection image of a carrier particle when the carrier particle is projected on a plane.

### [Particle Diameter of Carrier]

The specified resin dispersion type carrier constituting the double-component of the invention has a volume based median diameter of from 10 to 100 μm, and preferably from 15 to 80 μm. The volume based median diameter of the specified resin dispersion type carrier can be typically measured by a laser diffraction type particle size distribution measuring apparatus HEROS, manufactured by Sympatec Co., Ltd., having a wet type dispersing device.

When the volume based median diameter of the specified resin dispersion type carrier is less than 10 μm, the ratio of fine particles in the distribution of carrier particles and easily image wise adheres to the photoreceptor because the magnetic force per particle is lowered. When the volume based median diameter of the specified resin dispersion type carrier exceeds 100 μm, scattering of the toner is caused because the specific surface area of the carrier particle is reduced and the toner holding force is lowered.

The magnetization strength of the specified resin dispersion type carrier is preferably within the range of from 20 to 300 emu/cm³ in a magnetic field of 1 kOe.

### [Resistance of a Carrier]

Further, the specific resin dispersion type carrier has desirably a slightly low resistance (electric resistance), fore example 10⁹ to 10¹³ Ωcm, more desirably 10¹⁰ to 10¹² Ωcm. In the case that the resistance is 10⁹ Ωcm or less, the recovery rate of undeveloped toner in a developing device is increased and it is effective to refrain the formation of so-called developing ghost. However, the charge providing capability for toner is low not to charge tone sufficiently, whereby fogging may take place on a formed image. On the other hand, in the case that the resistance exceeds 10¹³ Ωcm, toner may be charged excessively.

The resistance of the specific resin dispersion type carrier is obtained such that after carrier is left for one day night under a normal temperature and normal humidity environment (20° C./50% RH), the carrier is put into a cylinder having a bottom surface of 1 cm² and made of a resin, the top and bottoms of the cylinder is sandwiched between electrodes, a load of 1 Kg is applied on the cylinder, a voltage of 1000V is applied between the electrodes, and an electric current is measured for 30 seconds, whereby a volume specific resistance can be measured.

The mixing ratio of toner and carrier in a two component developer relating to the present invention is determined to obtain a toner concentration of 3 to 20% by weight in the two component developer, preferably 4 to 15% by weight.

### <Image Forming Method>

The image forming method of the present invention is an image forming method of developing an electrostatic latent image formed on the surface of an electrostatic latent image carrying member with toner of a charged toner layer formed on a toner conveying roller arranged opposite to the electrostatic latent image carrying member.

An image forming apparatus used in the image forming method of the present invention is provided with an electrostatic latent image carrying member structured with for example, a rotating photoreceptor. On the periphery of the electrostatic latent image carrying member are arranged a charging device, an exposing device, a developing device described later in detail, a transfer device, a separating device and a cleaning device in this order. The image forming apparatus is further provided with a fixing device.

In the image forming method of the present invention, a high speed development is suitable in order to conduct developing with a hybrid developing method, for example, the line speed of the electrostatic latent image carrying member is preferably made within a range of from 100 to 500 mm/sec, preferably 150 to 400 mm/sec.

### <Developing Device>

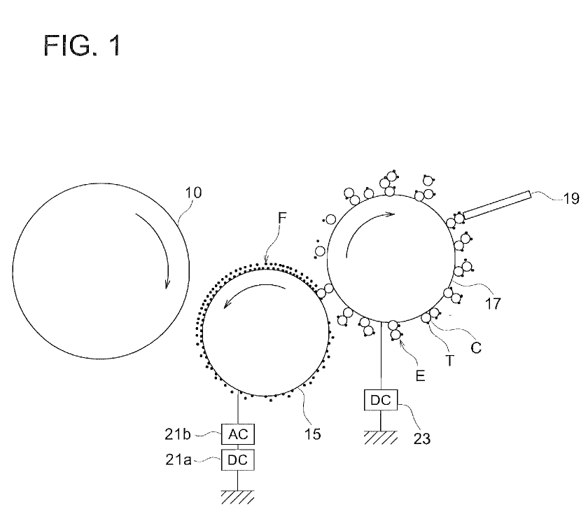

FIG. 1 shows a schematic diagram for explaining a hybrid developing method in the image forming method of the present invention.

The developing device comprises a sleeve-shaped magnetic roller 17 which has a fixed magnet therein and rotates while carrying magnetic brushes E formed with toner T and carrier C thereon, and a toner conveying roller 15 arranged opposite to the magnetic roller 17 so as to form a charged toner layer F thereon by the magnetic brushes formed on the magnetic roller 17. The developing device is arranged on a condition that the toner conveying roller 15 is opposite to the electrostatic latent image carrying member 10.

The toner conveying roller 15 and the magnetic roller 17 are made to rotate in the same direction in the region, for example, in which the toner conveying roller 15 and the magnetic roller 17 face to each other, also the electrostatic latent image carrying member 10 and the toner conveying roller 15 are made to rotate in the same direction, for example, in the region in which the electrostatic latent image carrying member 10 and the toner conveying roller 15 face to each other.

In FIG. 1, a DC power source 21a applies a DC bias voltage V_{dc1} onto the toner conveying roller 15, a AC power source 21b applies a AC bias voltage V_{ac} onto the toner conveying roller 15, a DC power source 23 applies a DC bias voltage V_{dc2} onto the magnetic roller 17, a brush height regulating blade 19 regulates the height of the magnetic brushes E to a predetermined height.

The uppermost surface of the toner conveying roller 15 is structured with aluminum, SUS, and a conductive resin, for example, it is made such that an external surface of a metallic core is formed with a cover layer composed of a semiconductor resin.

The gap (or toner cloud forming gap) between the magnetic roller 17 and the toner conveying roller 15 is preferably from 0.3 to 1.5 mm, for example.

Further, the gap between the brush height regulating blade 19 and the magnetic roller 17 is set to bring the magnetic brushes E in contact with the surface of the toner conveying roller 15 and although the gap becomes different depending on the size of carrier and a toner concentration in a two component developer, it may be set from 0.3 to 1.5 mm, for example, in a two component developer of carrier having a volume-based median size of 50 μm and toner having a toner concentration of 6%.

Further, the gap (or developing gap) between the toner conveying roller 15 and the electrostatic latent image carrying member 10 is set, for example, from 0.05 to 0.5 mm, preferably from 0.1 to 0.4 mm.

The developing device is provided with a toner recovering mechanism to recovery and recycle non developing toner having been not used for developing the electrostatic latent image among toner T constituting a charged toner layer F. The toner recovering mechanism may be a mechanism for exclusive use for toner recovery or a mechanism to recovery by rubbing the toner conveying roller 15 with magnetic brushes formed on the magnetic roller 17. In this recovery process, toner T is apt to receive stress to cause deterioration of a developer. However, since the specific resin dispersion type carrier constituting the two component developer used in the present invention has a high durability, the recovering mechanism employing these magnetic brushes may be adopted preferably.

In such a developing device, toner T and carrier C are stirred and charged with, for example, a paddle mixer or a stirring mixer, the charged toner is supplied onto the magnetic roller 17 to form magnetic brushes E. On the condition that the height of the magnetic brushes E is regulated by the brush height regulating blade 19, the magnetic brushes E are supplied in a tone cloud forming gap and then toner T constituting the magnetic brushes is let to jump or fly onto the surface of the toner conveying roller 15 by the action of an electric field formed by a voltage difference between the DC bias voltage V_{dc1} applied onto the toner conveying roller 15 by the DC power source 21a and the DC bias voltage V_{dc2} applied onto the magnetic roller 17 by the DC power source 23, whereby a charged toner layer F is formed with only toner T on the toner conveying roller 15. Further, when AC bias voltage V_{ac} is applied by the AC power source 21b in superimposition on the DC bias voltage V_{dc1} by the DC power source 21a on the toner conveying roller 15 in the developing gap, toner T in the charged toner layer F is let to fly from the toner conveying roller 15 to the electrostatic latent image carrying member 10, whereby a latent image formed on the electrostatic latent image carrying member 10 is developed.

The charge amount of the toner T is preferably from 5 to 20 μC/g, more preferably from 5 to 10 μC/g.

Here, the charge amount of the toner T is a value obtained by measuring a sample toner separated from a charged toner layer F formed on the toner conveying roller 15 under a normal temperature and normal humidity environment (20° C./50% RH) by a suction type charge amount measuring device.

The DC bias voltage V_{dc1} applied onto the toner conveying roller 15 by the DC power source 21a is set, for example, from 200 to 900 V, and a voltage difference between the DC bias voltage V_{dc1} and the DC bias voltage V_{dc2} applied onto the magnetic roller 17 by the DC power source 23 is set, for example, from 100 to 250 V, and with this, the thickness of the charged toner layer F formed on the toner conveying roller 15 is preferably made from 10 to 100 μm.

Further, the AC bias voltage V_{ac} applied by the AC power source 21b onto the toner conveying roller 15 is made such that, for example, a peak-to-peak voltage is 1.6 kV and a frequency is 2.7 kHz.

### <Fixing Method>

The present invention uses a specific two component developer. Since the specific two component developer rarely deteriorate, a developing can be conducted stably for a long term and a preferable effect can be obtained in a full color image formation. This method can be applied onto any image forming method such as a four cycle type image forming method constituted with four kinds of color developing devices for yellow, magenta, cyan and black and a single electrostatic latent image carrying member and a tandem type image forming method providing an image forming unit including a color developing device and an electrostatic latent image carrying member separately for each color.

In the case that the image forming method of the present invention is a full color image forming method, since developing is conducted stably for a long term, the color stability of the obtained color image can be maintained for a long term.

Further, since the two component developer used in the image forming method of the present invention hardly receive stress, a so-called toner recycling method can be adopted such that toner remained on an electrostatic latent image carrying member is recovered by a cleaning device and the recovered toner is returned to the developing device so as to be used again.

A fixing method in the above image forming method is not specifically limited.

### <Image Formation Support>

Examples of image formation supports on which an image is formed in the above image forming method, include an ordinary paper from a thin paper to a thick paper, a high quality paper, an art paper or a print paper such as a coated paper, a Japanese paper, a post card, a plastic film for OHP, and a cloth, and the image formation support is not limited to these papers.

According to the above mentioned image forming method, basically, since carrier is not brought in contact with a electrostatic latent image carrying member by adopting a hybrid developing method employing a toner conveying roller, brush marks of carrier are not formed on a developed image, a uniformity with a high image density can be obtained specifically even in a solid image, and a high image resolution can be obtained with achievement of a high reproducibility of a thin line by developing surly minute dots.

Further, since carrier constituting the two component developer is composed of resin-dispersion type carrier having a specific shape and has high durability, a stable charge providing capability can be obtained for a long term so that a charged toner layer with a high uniformity can be formed on the toner conveying roller. Accordingly, a stable developing ability can be obtained for a long term. As a result, a good image can be formed stably for a long term.

Further, usually, when carrier containing a phenol-formaldehyde resin is used, for example, the carrier caused water absorption in a usual contact type development with a two component developer, then water shifts to an electrostatic latent image carrying member, and successively so-called flow occurs on a surface potential of the electrostatic latent image carrying member resulting in that image blur may be induced. However, according to the image forming method of the present invention, since carrier does not cause the flow on a surface potential of the electrostatic latent image carrying member, occurrence of image blur may be refrained even if the carrier containing a phenol-formaldehyde resin is used.

### EXAMPLES

Examples carried out for confirming the effects of the invention are described below, but the invention is not limited to the examples.

### Carrier Producing Example 1

To each of magnetite (FeO.Fe₂O₃) powder having a number average primary particle diameter of 0.24 μm and α-Fe₂O₃ powder having a number average primary average diameter of 0.60 μm, 5.5% by weight of a silane coupling agent (3-(2-aminoethylaminopropyl)dimethoxysilane) was added, respectively, and rapidly stirred at 100° C. in a stirring vessel for oleophilizing the each of the metal oxide fine particles to prepare oleophilic magnetite powder A and oleophilic α-iron oxide powder A.

Composition (1) composed of 60 parts by weight of the oleophilic magnetite powder A, 40 parts by weight of oleophilic α-iron oxide powder A, 10 parts by weight of phenol and 6 parts by weight of a formaldehyde solution containing 40% by weight of formaldehyde, 10% by weight of methanol and 50% of water was added to a flask containing an aqueous medium containing 28% by weight of NH₄OH aqueous solution and heated by 85° C. spending for 40 minutes while stirring and subjected to thermally curing reaction for 3 hours while maintaining at this temperature and then cooled by 30° C. Water was further added and the supernatant was removed and remaining precipitate was washed by water, dried by air and further dried under reduced pressure of not more than 5 mmHg at 60° C. to obtain Carrier Particle [a].

A toluene coating solution containing 10% by weight of silicone resin was prepared and the coating solution was coated on Carrier Particles [a] as the core by evaporating the solvent while continuously applying shearing stress to the coating solution so that the coated amount of the resin was 1.0% by weight. After that, the coated layer was cured for 1 hour at 200° C. and loosed, and then classified by a sieve of 200 meshes to obtain specified resin dispersion type Carrier [A] coated with silicone resin on the surface thereof.

The specified resin dispersion type Carrier [A] had a volume based median diameter of 34 μm, a shape coefficient SF-1 of 1.04 and a shape coefficient SF-2 of 1.51. The strength of magnetization at 1 kOe was 129 emu/cm³. Further, the resistance was 3×10¹¹ Ωcm.

The volume based median diameter was measured by the laser diffraction type particle size distribution measuring apparatus HEROS, manufactured by Sympatec Co., Ltd., having a wet type dispersing device, and the shape coefficients SF-1 and SF-2 were determined by randomly taking magnified photograph of 100 particles of the carrier by a field emission scanning electron microscope S-4500, manufactured by Hitachi Seisakusho Co., Ltd., and analyzing the photograph by an image processing analyzing apparatus LUZEX 3, manufactured by Nicole Co., Ltd., and then calculating the average values derived from the following Expressions (SF-1) and (SF-2). The strength of magnetization was measured by a vibration magnetic field type automatic magnetic property recording apparatus BHV-30, manufactured by Riken Denshi Co., Ltd.

### Carrier Production Example 2

Carrier Particle [b] was obtained in the same manner as in Carrier Producing Example 1 except that Composition (2) composed of 100 parts by weight of oleophilic magnetite powder A, 10 parts by weight of phenol and 6 parts by weight of a formaldehyde solution composed of 40% by weight of formaldehyde, 10% by weight of methanol and 50% of water was used in place of Composition (1). The specified resin dispersion type Carrier [B] was prepared in the same manner as in Carrier Producing Example 1 except that the amount of the coated resin is varied to 1.5% by weight. The specified resin dispersion type Carrier [B] had a volume based median diameter of 39 μm, a shape coefficient SF-1 of 1.10 and a shape coefficient SF-2 of 1.15. The strength of magnetization at 1 kOe was 218 emu/cm³. Further, the resistance was 6×10¹¹ Ωcm.

### Carrier Production Example 3

Carrier particle [c] was obtained in the same manner as in Carrier Producing Example 2 except that oleophilic magnetite [B] was used as the oleophilic magnetite powder, which is obtained by adding 4.5% by weight of the silane coupling agent (3-(2-aminoethylaminopropyl)dimethoxsilane) to oleophilic magnetite powder and rapidly stirred and mixing at 100° C. in the mixing vessel for providing oleophilicity to the magnetite powder. The specified resin dispersion type Carrier [C] was obtained by using the carrier particle [c] in the same manner as in Carrier Production Example 1. The specified resin dispersion type Carrier [C] had a volume based median diameter of 41 μm, a shape coefficient SF-1 of 1.04 and a shape coefficient SF-2 of 1.95. The strength of magnetization at 1 kOe was 220 emu/cm³. Further, the resistance was 8×10¹¹ Ωcm.

### Carrier Producing Example 4

In a radical polymerizable monomer composition composed of 8 parts by weight of styrene, 2 parts by weight of 2-ethylhexyl acrylate, 1 part by weight of divinylbenzene, 60 parts by weight of the oleophilic magnetite powder A and 40 parts by weight of the oleophilic α-iron oxide were dispersed and 0.3 parts by weight of a radical polymerization initiator (lauroyl peroxide) was added to prepare a carrier forming liquid.

On the other hand, 600 parts by weight of deionized water and 500 parts by weight of a 0.1 moles/L aqueous solution of Na₃PO₄ were charged in a 2 L four-mouth flask having a high speed mixing device TK type Homomixer, manufactured by Tokushu Kika Kogyo Co., Ltd., and a baffle plate, and heated by 65° C., and then 70 parts by weight of a 1.0 mol/L aqueous solution of CaCl₂ was gradually added while stirring at 14,000 rμm to prepare an aqueous medium containing extremely fine particle of sparingly soluble dispersion stabilizer of Ca₃(PO₄)₂. Then the carrier forming liquid was added into the aqueous medium and oil droplets of the carrier forming liquid were formed in the aqueous medium by stirring at 14,000 rpm by the high speed stirring device KT type Homomixer, manufactured by Tokushu Kika Kogyo Co., Ltd. After that, the stirrer was changed to a propeller type stirring wing and the system was heated by 75° C. and subjected to polymerization reaction for 8 hours. Then the system was cooled and hydrochloric acid was added to remove the dispersion stabilizer. Thereafter, the droplets were filtered, washed and dried to obtain the specified dispersion type Carrier [d].

The specified resin dispersion type Carrier [D] in the same manner as in Carrier Production Example 1 using the specific resin dispersion Carrier [d] as the core particle.

The specified resin dispersion type Carrier [D] had a volume based median diameter of 44 μm, a shape coefficient SF-1 of 1.05 and a shape coefficient SF-2 of 1.31. The strength of magnetization at 1 kOe was 129 emu/cm³. Further, the resistance was 9×10¹¹ Ωcm.

### Comparative Carrier Production Example 1

Comparative Carrier [E] composed of silicone resin coated Li-ferrite particle prepared by a sintering method which had a shape coefficient SF-1 of 1.3 and a shape coefficient SF-2 of 2.52 was prepared. The volume based median diameter of this carrier was 45 μm. Further, the resistance was 6×10⁹ Ωcm.

### Comparative Carrier Production Example 2

To 100 parts by weight of polyester resin having a softening point of 150° C., 900 parts by weight of magnetite powder having a number average primary particle diameter of 0.24 μm was added, and melted and kneaded by a biaxial extruder. Then the resultant matter was crushed by a mechanical crushing machine. Thus crushed powder having a volume based median diameter of 38 μm was obtained. The shape of crushed powder was made to sphere by heating at 180° C. for 5 seconds by an instantaneous heat treating apparatus and the resultant particles were coated by the silicone resin in the same manner as in Carrier Production Example 1 to prepare Comparative Carrier [F].

The specified resin dispersion type Carrier [F] had a volume based median diameter of 39 μm, a shape coefficient SF-1 of 1.02 and a shape coefficient SF-2 of 1.04. The strength of magnetization at 1 kOe was 218 emu/cm³, and further, the resistance was 7×10¹² Ωcm.

### Toner Production Example Bk1

Into a 2 L four-mouth flask provided with the high speed mixing apparatus TK type Homomixer, manufactured by Tokushu Kika Kogyo Co., Ltd., and a baffle plate, 600 parts by weight of deionized water and 500 parts by weight of a 0.1 mols/L Na₃PO₄ aqueous solution were charged and heated by 65° C. and then 70 parts by weight of a 1.0 mol/L aqueous solution of CaCl₂ was gradually added while stirring at 12,000 rpm to prepare an aqueous medium containing extremely fine particle of sparingly soluble dispersion stabilizer of Ca₃(PO₄)₂.

On the other hand, 78 parts by weight of styrene, 22 parts by weight of 2-ethylhexyl acrylate, 7 parts by weight of carbon black, 9 parts by weight of Parting Agent 2 and 1 part by weight of Parting Agent 6 were mixed and dispersion treated for 3 hours by ATTRITER, manufactured by Mitsui Kinzoku Co., Ltd., and then 8 parts by weight of 2,2′-azobis(2,4-dimethyl-varelonitrile) was added to prepare a toner forming polymerizable monomer composition.

The toner forming polymerizable monomer composition was added to the above aqueous medium and stirred at 12,000 rpm by the high speed stirring machine for 15 minutes under nitrogen atmosphere at a interior temperature of 65° C. to form toner particles. After that the stirring machine was replaced by a propeller wing stirrer, and the above resultant suspension was maintained at the same temperature for 10 hours while controlling the particle shape by the rotating rate of the stirrer wing and the angle of the baffle plate to complete the polymerization treatment. After that, the suspension was cooled and diluted hydrochloric acid was added for removing the dispersion stabilizer, and then the suspended particles were separated and repeatedly washed and dried to obtain Toner Particle (Bk-1).

Toner Particle (Bk-1) had a volume based median diameter of 6.5 μm, a peak molecular weight of 14,000, a molecular weight distribution ((Mw/Mn) of 8 and a softening point of 125° C.

The volume based median diameter was determined according to the particle size distribution within the range of from 2.0 to 40 μm measured by Coulter Multisizer, manufactured by Coulter Co., Ltd., using an aperture of 50 μm. The peak molecular weight and the molecular weight distribution were measured by gel permeation chromatography, and the softening point was measured by a Koka type flow tester.

Black Toner (Bk-1) was obtained by dry state mixing 100 parts by weight of Toner Particle (Bk-1) and silica fine powder having a BET specific area of 140 m²/g and treated by silicone oil using a HENSCHEL MIXER.

The shape and particle diameter of Toner Particle (Bk-1) were not varied by the addition of the silica fine particles.

### Production Example of Toners Y1, M1 and C1

A yellow toner Y1, magenta toner M1 and cyan toner C1 were each produced in the same manner as in the toner producing example Bk-1 except that the carbon black was replaced by C. I. Pigment Yellow 74, C. I. Pigment Red 122 and I. C. Pigment Blue 15:3, respectively.

### Production Examples of Two Component Developers Bk1 to C6

Two component Developers Bk1 to C4 and comparative two component Developers Bk5 to C6 were prepared by combining Toners Bk1 to C1, and Carriers A to D, and comparative Carrier E and F as shown in Table 4 and by mixing them so that the toner concentrate was made to 6%.

TABLE 1

| Developer No. | | Carrier No. | Toner No. |
|---|---|---|---|
| Inventive | Bk1 | A | Bk1 |
| | Y1 | A | Y1 |
| | M1 | A | M1 |
| | C1 | A | C1 |
| | Bk2 | B | Bk1 |
| | Y2 | B | Y1 |
| | M2 | B | M1 |
| | C2 | B | C1 |
| | Bk3 | C | Bk1 |
| | Y3 | C | Y1 |
| | M3 | C | M1 |
| | C3 | C | C1 |
| | Bk4 | D | Bk1 |
| | Y4 | D | Y1 |
| | M4 | D | M1 |
| | C4 | D | C1 |
| Comparative | Bk5 | E | Bk1 |
| | Y5 | E | Y1 |
| | M5 | E | M1 |
| | C5 | E | C1 |
| | Bk6 | F | Bk1 |
| | Y6 | F | Y1 |
| | M6 | F | M1 |
| | C6 | F | C1 |

### Examples 1 to 4 and Comparative Examples 1 to 2

Practical copying test was carried out in which a composite image divided into a full color image having a pixel ratio of each color of 5% and a resolution of 1200 dpi and a solid black image was printed 50,000 sheets was printed in an one by one intermittent mode under a high temperature and high humidity condition (32° C. and 85% RH) using each of the above obtained two components Developers Bk1 to C4 and comparative two component Developers Bk5 to C6 in the combination shown in Table 2 by a digital copying machine bizhub Pro C350, manufactured by Konica Minolta Co., Ltd, in which the developing device shown in FIG. 1 was installed. The absolute reflective densities of 15 optional points on the solid black portions of the first and 50,000^{th} prints were measured by a reflective densitometer RD-918, manufactured by Macbeth Co., Ltd., and the solid black image density unevenness was evaluated by the difference the maximum value and the minimum value among the 15 measured values. Moreover, for the full color image portions of the first and 50,000^{th} prints, the area of the color reproducible range was measured from the L*a*b* color space graph of each of the full color image by the use of a color-difference meter CM-2002, manufactured by Minolta Co., Ltd. The area of color reproducible range of the 50,000^{th} print was calculated when the area of the first print was set at 100, thereby evaluating the color reproducible range. Results are shown in Table 2.

### <Developing Apparatus>

The developing apparatus having the structure shown in FIG. 1 was used. Detailed developing conditions are as follow.

Toner conveying roller 15: aluminum roller

Magnetic roller: SUS (stainless-steel) cylindrical roller in which a fixed magnet is installed

DC bias voltage V_{dc1} by DC power source 21a: 400 V

AC bias voltage V_{ac} by AC power source 21b: 1.6 kV (peak-to-peak voltage), 2.7 kHz (frequency)

DC bias voltage V_{dc2} by DC power source 23: 200 V

Toner cloud forming gap 0.5 mm

Developing gap: 0.2 mm

Gap between a brush regulating blade and a magnetic roller: 1.0 mm

TABLE 2

| | Combination | Solid black image | | |
|---|---|---|---|---|
| | of two | density unevenness | | Color |
| | component | | 50,000^{th} | reproducible |
| | developer | The first | prints | range (%) |
| Inv. Ex. 1 | Bk1/Y1/M1/C1 | 0.01 | 0.02 | 98 |
| Inv. Ex. 2 | Bk2/Y2/M2/C2 | 0.01 | 0.02 | 98 |
| Inv. Ex. 3 | Bk3/Y3/M3/C3 | 0.01 | 0.02 | 98 |
| Inv. Ex. 4 | Bk4/Y4/M4/C4 | 0.02 | 0.03 | 98 |
| Com. Ex. 1 | Bk5/Y5/M5/C5 | 0.01 | 0.13 | 82 |
| Com. Ex. 2 | Bk6/Y6/M6/C6 | 0.01 | 0.17 | 80 |

As can be seen from the result indicated in Table 2, In Inventive Examples 1 to 4, a sufficient image density can be obtained in an image formed after 50,000^{th} prints and a wide color reproducible range can be achieved.

What is claimed is:

1. An image forming method, comprising the steps of:
(1) agitating a mixture of toner particles and carrier particles so as to electrically charge the toner particles;
(2) forming a charged toner layer on a toner conveying roller by moving the charged toner particles from the mixture;
(3) forming an electrostatic latent image on an image carrying member; and
(4) conveying the charged toner layer by the toner conveying roller so as to develop the electrostatic latent image on the image carrying member with charged toner;
wherein the carrier particles are carrier particles each formed by dispersing magnetic powder in a binder resin and have a shape coefficient SF-1 of 1.0 to 1.2, a shape coefficient SF-2 of 1.1 to 2.5, and a volume-based median size of 10 to 100 μm.

2. The image forming method of claim 1, wherein the carrier particles are adapted to form a magnetic brush on a magnetic roller located opposite to the toner conveying roller and an electric field is applied to the magnetic brush attracting the charged toner particles thereon so as to let the charged toner particles to move from the magnetic brush to the toner conveying roller so that a charged toner layer is formed on the toner conveying roller.

3. The image forming method of claim 1, wherein in a region in which the magnetic roller and the toner conveying roller face each other, the magnetic roller and the toner conveying roller rotate in the same direction.

4. The image forming method of claim 1, wherein the gap between the magnetic roller and the toner conveying roller is from 0.3 mm to 1.5 mm.

5. The image forming method of claim 1, wherein the height of the magnetic brush is regulated so as to rub the surface of the toner conveying roller.

6. The image forming method of claim 5, wherein the magnetic brush removes and recovers residual toner particles having not used for development among the charge toner particles from the toner conveying roller.

7. The image forming method of claim 1, wherein a DC bias voltage is applied in such way that a voltage between the magnetic roller and the toner conveying roller is 100 to 250 V.

8. The image forming method of claim 1, wherein the thickness of the charged toner layer formed on the toner conveying roller is 10 to 100 μm.

9. The image forming method of claim 1, wherein the gap between the toner conveying roller and the image carrying member is 0.05 mm to 0.5 mm.

10. The image forming method of claim 1, wherein a DC bias voltage and an AC bias voltage superimposed on the DC bias voltage are applied between the toner conveying roller and the image carrying member so as to let the charged toner particles to move from the toner conveying roller to the image carrying member.

11. The image forming method of claim 1, wherein the binder resin constituting each of the carrier particles includes at least one kind of a styrene-acryl resin, a polyester resin, a fluoro resin, a phenol formaldehyde resin, an epoxy resin, a urea resin and a melamine resin.

12. The image forming method of claim 1, wherein the binder resin constituting each of the carrier particles includes a phenol formaldehyde resin.

13. The image forming method of claim 1, wherein each of the carrier particles is covered with a resin.

14. The image forming method of claim 1, wherein the carrier particles contain the magnetic powder in an amount of 40 to 99% by weight.

15. The image forming method of claim 1, wherein the carrier particles have a magnetization strength of 20 to 300 emu/cm³ in a magnetic field of 1 kOe.

16. The image forming method of claim 1, wherein the carrier particles have an electric resistance of 10⁹ to 10¹³ Ωcm.

17. The image forming method of claim 1, wherein the magnetic powder has a number average primary size of 0.1 to 0.5 μm.

18. The image forming method of claim 1, wherein line speed of the electrostatic latent image carrying member is made within a range of from 100 to 500 mm/sec.

19. An image forming method comprising:
developing an electrostatic latent image formed on an image carrying member with a toner in a charged toner layer formed on a toner conveying roller located opposite to the image carrying member; the charged toner layer on the toner conveying roller being formed by use of a two component developer including the toner and a carrier; the carrier having magnetic powder dispersed in a binder resin; and the carrier having a shape coefficient SF-1 of from 1.0 to 1.2, a shape coefficient SF-2 of from 1.1 to 2.5 and a volume-based median size of from 10 to 100 μm.

20. The image forming method of claim 19, wherein the binder resin constituting each of the carrier particles includes a phenol formaldehyde resin.
